(19) United States
(12) Patent Application Publication
(10) Pub. No.: US 2019/0144313 A1
(43) Pub. Date: May 16, 2019

(54) DISINFECTION METHOD FOR WATER AND WASTEWATER

(71) Applicant: PeroxyChem LLC, Philadelphia, PA (US)

(72) Inventors: Philip BLOCK, Garnet Valley, PA (US); Weidong AN, Williamsville, NY (US); Angela THOMPSON, East Amherst, NY (US); Coryn MITTIGA, Tonawanda, NY (US)

(73) Assignee: PeroxyChem LLC, Philadelphia, PA (US)

(21) Appl. No.: 16/191,757

(22) Filed: Nov. 15, 2018

Related U.S. Application Data
(60) Provisional application No. 62/587,012, filed on Nov. 16, 2017.

(51) Int. Cl. C02F 1/68

(52) U.S. Cl. CPC C02F 1/68; C02F 2103/001

(57) ABSTRACT

Provided herein are methods and compositions for water disinfection. The methods and compositions, which can include a peracid and a source of iodine, are useful for treatment of water contaminated with recalcitrant microbes.

### CROSS-REFERENCE TO RELATED APPLICATIONS

This application claims priority under 35 U.S.C. § 119(e)(1) from U.S. Provisional Application Ser. No. 62/587,012, filed on Nov. 16, 2017, the contents of which are incorporated herein by reference.

### FIELD OF THE INVENTION

The present invention relates to a method of water disinfection, for example, wastewater, by contacting the water with combination of a peracid, such as peracetic acid (PAA), and a source of iodine.

### BACKGROUND OF THE INVENTION

The treatment of water and wastewater, including household sewage and runoff, typically involved a multistep process to reduce physical, chemical and biological contaminants to acceptable limits, before such water or wastewater can be safely returned to the environment. Among the steps typically employed in a water treatment facility is a disinfection step, in which the water or wastewater is treated to reduce the levels of microorganisms present. Standard disinfection methods typically involve treatment with chlorine or chlorinated compounds, ozone, or ultraviolet light. Standard methods are not always effective for the rapid elimination of recalcitrant microorganisms, for example, Enterococci. There is a continuing need for methods of elimination of recalcitrant microorganisms in a timely and cost-effective manner.

### SUMMARY OF THE INVENTION

Provided herein are materials and methods for water disinfection. The water can be drinking water, industrial wastewater, municipal wastewater, combined sewer overflow, process water, rain water, flood water, and storm runoff water. The method can include adding a peracid and iodine to the water and maintaining the contact of the water with the peracid and the iodine for a time sufficient to reduce the concentration of microorganisms in the water. In some embodiments the water has previously undergone primary or secondary purification treatment.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a graph showing the log reduction of Escherichia coli (E. coli) as a function of time at a PAA concentration of 0.5 mg/L (0.5 ppm) and iodine concentrations of 0.2 ppm and 0.6 ppm

FIG. 2 is a graph showing the log reduction of Escherichia coli (E. coli) as a function of time at a PAA concentration of 1.0 mg/L (1.0 ppm) and iodine concentrations of 0.2 ppm and 0.6 ppm

FIG. 3 is a graph showing the log reduction of Enterococci as a function of time at a PAA concentration of 0.5 mg/L (0.5 ppm) and iodine concentrations between 0.2 ppm and 0.6 ppm

FIG. 4 is a graph showing the log reduction of Enterococci as a function of time at a PAA concentration of 1.0 mg/L (1.0 ppm) and iodine concentrations of 0.2 ppm and 0.6 ppm

FIG. 5 is a graph showing the log reduction of MS bacteriophage as a function of time at a PAA concentration of 5 mg/L (0.5 ppm) and iodine concentrations of 1 ppm and 3 ppm.

### DETAILED DESCRIPTION

The treatment of water and wastewater so that it can be safely returned to the environment typically involves a number of processes to remove physical, chemical and biological contaminants. In general, sewage effluent is first mechanically screened at a regulated flow to remove large objects such as sticks, packaging cans, glass, sand, stones and the like which could possibly damage or clog the treatment plant if permitted to enter. The screened wastewater is then typically sent through a series of settling tanks, where sludge settles to the bottom, while grease and oils rise to the surface. After the sludge is removed and the surface materials skimmed off, the wastewater is typically treated with microorganisms to degrade any organic contaminants. This biological treatment ultimately produces a floc, that is an aggregate of fine suspended particles, which is typically removed by filtration, through either sand or activated carbon. In the final stages of treatment, the microorganism content of the filtered water is reduced by disinfecting methods. A disinfectant can be added to the wastewater stream and passed through a disinfectant contact chamber. Contact of the wastewater with the disinfectant is typically maintained for a sufficient period of time to reduce the microorganism level to the desired extent.

In most water treatment plants, chlorine or chlorinated compounds are employed as the disinfectant. Ozone and ultraviolet light treatments are also used. The use of peracids has also been proposed, but their use has yet to become widespread.

U.S. federal and state regulatory agencies rely upon the use of microbial indicator organisms in routine monitoring of water disinfection. Because it is impractical to test water for every potential waterborne pathogen, regulatory agencies have determined that the reduction in levels of such indicator organisms provides a surrogate measure for reduction of pathogens in general, particularly those found in human and animal excretia. Fecal coliforms were one of the first bacterial indicator organisms used to assess microbial reduction. Escherichia coli has become the predominant indicator organism in many states throughout the U.S. More recently, many states have adopted the use of Enterococcus faecalis as an indicator organism. Enterococcus faecalis is more difficult to inactivate than E. coli and thus is a more conservative indicator with respect to public safety. The use of bacteriophage, that is, viruses that infect pathogenic bacteria, as indicator organisms is also currently under consideration by the United States Environmental Protection Agency.

As the indicator organisms used to demonstrate suitable reductions in microbial concentrations become more challenging to inactivate, increased dose concentrations of the disinfectant, such as peracetic acid, sodium hypochlorite or chloramines, or longer contact times may be needed to achieve the desired reduction in the concentration of the indicator organism. However, this strategy may be impractical due to constraints in the disinfection contact basin or from an economical point of view, where increased disinfectant concentration may no longer be cost-effective.

Typical contact times for the water and the disinfectant, for example, chlorine, at wastewater treatment plants can range from about twenty minutes to about an hour. These short content times may be effective for inactivation of many species of bacteria and viruses. However, they may be less effective for the treatment of more recalcitrant microbes, for example, E. faecalis or bacteriophage.

The inventors have found that treatment of microorganism-containing water with a peracid, such as peracetic acid, along with a source of iodine resulted in increased efficacy against microbial indicator organisms. More specifically, the combination of peracetic acid and iodine provided a substantial reduction in the levels of indicator organisms at lower concentrations of peracetic acid and at shorter contact times.

Useful peracids for the methods disclosed herein are peracetic acid (peroxyacetic acid or PAA) or performic acid, or a combination thereof. Peracetic acid is typically used as an aqueous equilibrium mixture of acetic acid, hydrogen peroxide, peracetic acid and water. The weight ratios of these compounds can vary depending. Exemplary PAA solutions are those having weight ratios of PAA:hydrogen peroxide:acetic acid from 12-18:21-24:5-20; 15:10:36; 15:10:35; 35:10:15; 20-23:5-10:30-45 and 35:10:15.

Other organic peracids (also called peroxyacids) suitable for use in the the methods disclosed herein include one or more C₁ to C₁₂ peroxycarboxylic acids such as monocarboxylic peracids and dicarboxylic peracids. These peracids can be used individually or in combinations of two, three or more peracids. The peroxycaboxylic acid can be a C₂ to C₅ peroxycarboxylic acid such as a moncarboxylic peracid or a dicarboxylic peracid. The peracid should be at least partially water-soluble or water-miscible.

One suitable category of organic peracids includes peracids of a lower organic aliphatic monocarboxylic acid having 1-5 carbon atoms, such as formic acid, acetic acid ethanoic acid), propionic acid propanoic acid), butyric acid (butanoic acid), iso-butyric acid (2-methyl-propanoic acid), valeric acid (pentanoic acid), 2-methyl-butanoic acid, iso-valeric acid (3-methyl-butanoic) and 2,2-dimethyl-propanoic acid. Organic aliphatic peracids having 2 or 3 carbon atoms, e.g., peracetic acid and peroxypropanoic acid, are also suitable.

Another category of suitable lower organic peracids includes peracids of a dicarboxylic acid having 2-5 carbon atoms, such as oxalic acid (ethanedioic acid), malonic acid (propanedioic acid), succinic acid (butanedioic acid), maleic acid (cis-butenedioic acid) and glutaric acid (pentanedioic acid).

Peracids having between 6-12 carbon atoms that can be used in the methods disclosed herein include peracids of monocarboxylic aliphatic acids such as caproic acid (hexanoic acid), enanthic acid (heptanoic acid), caprylic acid (octanoic acid), pelargonic acid (nonanoic acid), capric acid (decanoic acid) and lauric acid (dodecanoic acid), as well as peracids of monocarboxylic and dicarboxylic aromatic acids such as benzoic acid, salicylic acid and phthalic acid (benzene-1,2-dicarboxylic acid).

The iodine can be in a powder or liquid form, for example an aqueous solution. Aqueous solutions of iodine can include multiple iodine species including iodide (I⁻), molecular iodine (I₂), hypoiodous acid (HOI), iodate (IO₃⁻), triiodide (I₃⁻) and polyiodides such as I₅ or I₇). Aqueous iodine solutions can range from about a 1% to about a 30% solution. An exemplary iodine solution can be a 0.1 N aqueous solution obtained from Alfa Aesar or other commercial source. In some embodiments, the iodine can be an iodine salt, for example potassium iodide. In some embodiments, the iodine can be pelletized or powdered.

The peracid and the iodine can added to the water to be treated from separate stocks or stock solutions. The peracid, for example peracetic acid, and the iodine can be added to the water to be treated either simultaneously or sequentially. In some embodiments, the iodine can be added to the water before the peracid is added. Alternatively, the iodine can be added to the water after the peracid is added. In some embodiments, the water or wastewater can be a water or wastewater stream. The iodine can be added to the stream simultaneously with the peracid, at the same application point, or in sequence with the peracid, added either before or after the peracid, When the peracid and the iodine are added sequentially, the time between the additions of the two components can vary depending on many factors including the configuration of the treatment facility. For example, the addition of the first component, either peracetic acid or iodine, and the addition of the second component, either iodine or peracetic acid, can be separated by a time of about 20 seconds to about 60 minutes or more.

The location of the iodine addition relative to the peracid addition point can be adjusted spatially to achieve a desired interval between addition of the two chemicals in order to optimize the antimicrobial activity. The order of addition can also take into account water or wastewater flowrates and the hydraulics associated with the specific disinfection contact chamber.

The peracid can be added to the water to be treated in concentrations that effectively reduce the levels of the population of microorganisms in the water sample. The optimum concentration will depend upon many factors, including, for example, the level of microorganisms in the water, the species of microorganisms in the water; the degree of disinfection desired; the time for which the wastewater treated remains in the contact chamber; the presence of other materials in the water, and the water temperature.

In general, when the peracid employed is PAA, the total amount of PAA added should be sufficient to ensure that a concentration of between 0.5 and 50 parts per million by weight (“ppm”) of PAA, for example, of between 1 ppm and 30 ppm of PAA, is present in the wastewater to be treated.

Iodine can be added in concentrations that effectively increase the antimicrobial activity of the peracid. The optimum concentration will depend on many factors, including, for example, the level of microorganisms in the water, the species of microorganisms in the water; the time for which the water and wastewater will remain in contact with the iodine and the peracid, and the amount of peracid added to the water or wastewater. In general, the amount of iodine to be added should not exceed levels that would be significantly toxic to aquatic wildlife following the release of the treated water from the treatment facility.

In general, the total amount of iodine added should be sufficient to provide a concentration between 0.01 and 2 parts per million by weight (“ppm”) of iodine in the water to be treated.

The length of time that the water or wastewater is contacted with the peracid and the iodine can vary. Contact times can range from about five minutes to about two hours, for example, about 5 minutes, about 10 minutes, about 15 minutes, about 20 minutes, about 25 minutes, about 30 minutes, about 35 minutes, about 40 minutes, about 45 minutes, about 50 minutes, about 55 minutes, about 60 minutes, about 65 minutes, about 70 minutes, about 75 minutes, about 80 minutes, about 85 minutes, about 90 minutes, about 100 minutes, about 110 minutes, about 120 minutes, about 130 minutes, about 140 minutes, about 150 minutes, about 160 minutes, about 170 minutes, about 180 minutes.

The treated water or wastewater can be released from the treatment facility at the end of the contacting step. In some embodiments, additional steps can be included prior to release of the treated water or wastewater. The additional steps can include contacting the water with a quencher to quench the activity of the PAA. Alternatively or in addition, the treated water can be passed through additional filters to remove any remaining particulate matter.

Methods of determining the concentration of a microorganism in water can vary depending upon many factors including, for example, the species of microorganism, the source and purity of the water, and the time constraints involved. Exemplary methods include culturing methods, such as plate counts; biochemical methods such as adenosine triphosphate detection or measurement of nutrient indicators; nucleic acid analysis, for example, polymerase chain reaction based methods; immunological methods, for example, antibody-based detection of microbial markers; and optical methods. Regardless of the method, the reduction of the concentration of microorganisms is typically assayed on a logarithmic scale. For example, a three log reduction in the number of colony forming units present in a sample would result in 1000 times fewer colony forming units in the sample.

### EXAMPLES

### Example 1: Treatment of E. coli with PAA and Iodine

A bench scale test was performed using a non-disinfected, secondary effluent sample from a wastewater treatment facility. The wastewater sample was collected and shipped to the laboratory, and testing was conducted within twenty-four hours. The wastewater sample was split into 100 mL aliquots and placed into clean, disinfected glass jars and placed on a jar-stirrer apparatus. The wastewater aliquots were inoculated with E. coli to achieve a target concentration of 320,000 MPN (most probable number)/100 mL (5.5 log).

A peracetic acid (PAA) equilibrium solution (15% peracetic acid/23% hydrogen peroxide) was added to the water, with stirring, to provide a final concentration of either 0.5 ppm or 1 ppm PAA. Immediately following the addition of peracetic acid (that is, within about 10 seconds), iodine (0.1 N aqueous iodine, Alfa Aesar) was added to the water to provide final concentrations of either 0.2 mg/L or 0.6 mg/L of iodine. Control samples included: 1) samples that contained PAA but no iodine; 2) samples that did not contain either PAA or iodine.

At 15, 30 and 45 minutes after the PAA and the iodine were added to the water, samples were removed and neutralized with sodium bisulfate to decompose the PAA and iodine and stop the microbial inactivation. E. coli levels in the water samples were determined using IDEXX Colisure™.

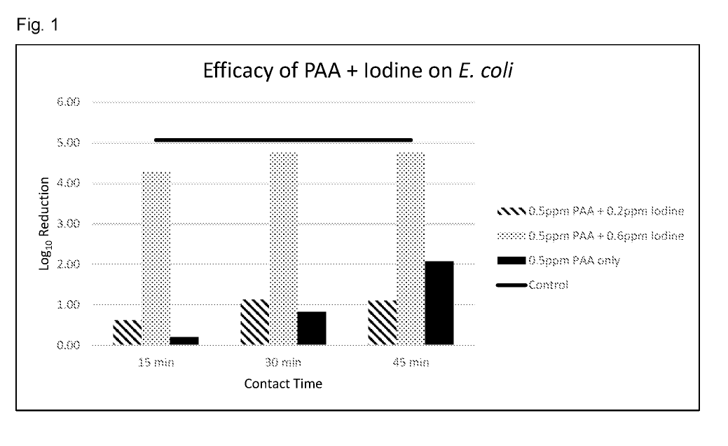

The effect of PAA and iodine on the reduction of E. coli as a function of contact time is shown in FIG. 1. The striped bars represent the samples that included PAA plus 0.2 ppm iodine. The addition of 0.2 ppm of iodine increased the microbial log reduction of 0.5 ppm PAA by half an additional log, compared to PAA alone, in the first 15 minutes of contact. The addition of 0.6 ppm iodine (represented by the stippled bars in FIG. 1) increased the microbial log reduction of 0.5 ppm PAA by an additional 3.5-4 logs, compared to PAA alone (represented by the black bars in FIG. 1), within the first 15 minutes of contact. These data showed that the antimicrobial activity of low concentrations of PAA against the microbial indicator organism E. coli was significantly increased by the addition of iodine. In addition, the significant increase was seen for even the shortest contact time of 15 minutes.

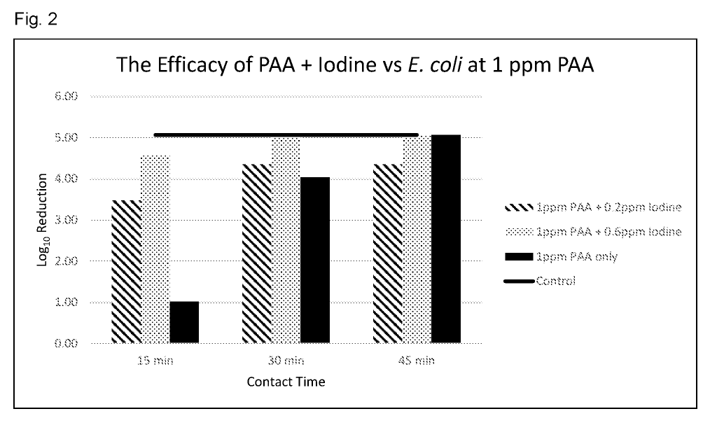

FIG. 2 shows the results of a similar experiment in which the PAA concentration was 1 ppm and the iodine concentrations were 0.2 ppm and 0.6 ppm. As shown in FIG. 2, the antimicrobial activity of 1 ppm PAA was significantly increased by the addition of iodine for contact times of 15 and 30 minutes.

### Example 2: Treatment of Eneterococci with PAA and Iodine

A bench scale test was performed using a non-disinfected, secondary effluent sample from a wastewater treatment facility. The wastewater sample was collected and shipped to the laboratory, and testing was conducted within twenty-four hours. The wastewater sample was split into 100 mL aliquots and placed into clean, disinfected glass jars and placed on a jar-stirrer apparatus. The wastewater aliquots were inoculated with Enterococcus faecalis (American Type Culture Collection 29212) that had been grown in TSB overnight at 35° C., to achieve a target concentration of 320,000 MPN/100 mL (5.5 log).

A peracetic acid (PAA) equilibrium solution was added to the water to provide a final concentration of either 0.5 ppm or 1 ppm PAA. Following the addition of peracetic acid, iodine was added to the water to provide final concentrations of either 0.2 mg/L or 0.6 mg/L of iodine. Two kinds of control samples were included in this experiment: 1) samples that included PAA but no iodine; 2) samples that did not include either PAA or iodine.

At 15, 30 and 45 minutes after the PAA and the iodine were added to the water, samples were removed and neutralized with sodium bisulfate to decompose the PAA and iodine and stop the microbial inactivation. Enterococci levels in the water samples were determined using IDEXX Enterolert™.

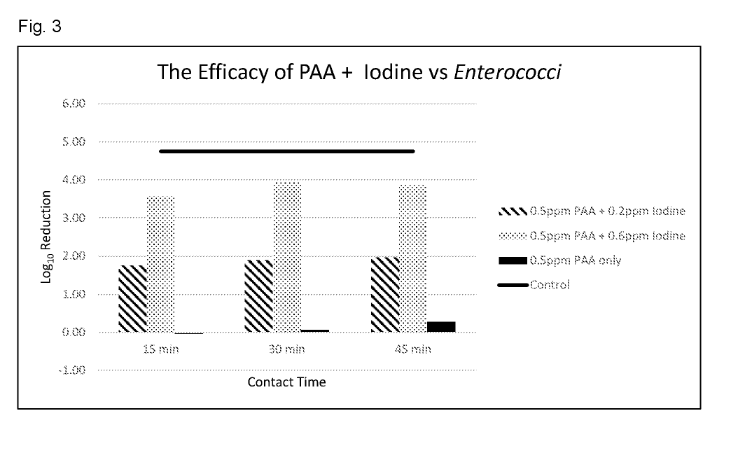

The effect of 0.5 ppm PAA and iodine on the reduction of Enterococci as a function of contact time is shown in FIG. 3. The striped bars represent the samples that included PAA plus 0.2 ppm iodine The addition of 0.2 ppm of iodine increased the microbial log reduction of 0.5 ppm PAA by nearly 2 log units, compared to PAA alone, in the first 15 minutes of contact. The addition of 0.6 ppm iodine (represented by the stippled bars in FIG. 1) increased the microbial log reduction of 0.5 ppm PAA by an nearly 4 log units, compared to PAA alone (represented by the black bars in FIG. 3), within the first 15 minutes of contact. These data showed that the antimicrobial activity of low concentrations of PAA against the microbial indicator organism Enterococcus was significantly increased by the addition of iodine. In addition, the significant increase was seen for even the shortest contact time of 15 minutes. This increase was sustained at the 30 and 45 minute contact times.

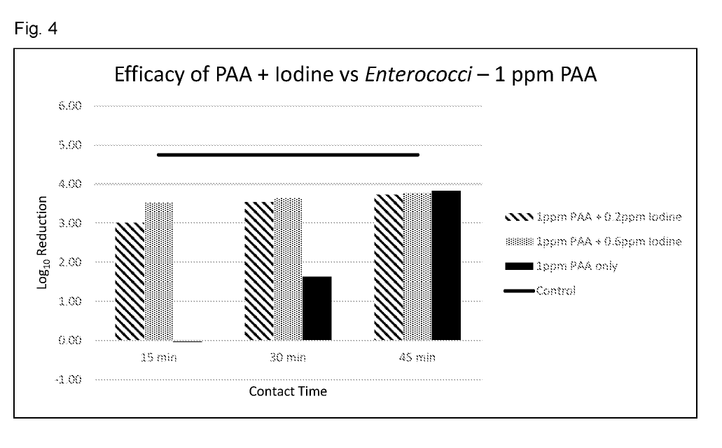

FIG. 4 shows the results of a similar experiment in which the PAA concentration was 1 ppm and the iodine concentrations were 0.2 ppm and 0.6 ppm. As shown in FIG. 4, the antimicrobial activity of 1 ppm PAA against the microbial indicator organism Enterococcus was significantly increased by the addition of iodine for contact times of 15 and 30 minutes.

### Example 3: Treatment of MS2 Bacteriophage with PAA and Iodine

A bench scale test was performed using a non-disinfected, secondary effluent sample from wastewater treatment facility. The wastewater sample was collected and shipped to the laboratory, and testing was conducted within twenty-four hours. The wastewater sample was split into 100 mL aliquots and placed into clean, disinfected glass jars and placed on a jar-stirrer apparatus. The wastewater aliquots were inoculated MS2 bacteriophage to achieve a target concentration of 320,000 MPN/100 mL (5.5 log).

A peracetic acid (PAA) equilibrium solution was added to the water to provide a final concentration of 5 ppm. Following the addition of PAA, iodine was added to the water to provide final concentrations of either 1 ppm or 3 ppm. Control samples included: 1) samples that contained iodine but no PAA; 2) samples that did not contain either PAA or iodine.

At 15, 30, 45, and 90 minutes after the PAA and the iodine were added to the water, samples were removed and neutralized with sodium bisulfate to decompose the PAA iodine and stop the microbial inactivation. MS2 bacteriophage levels in the water samples were determined using double agar layer assay with an E. coli host.

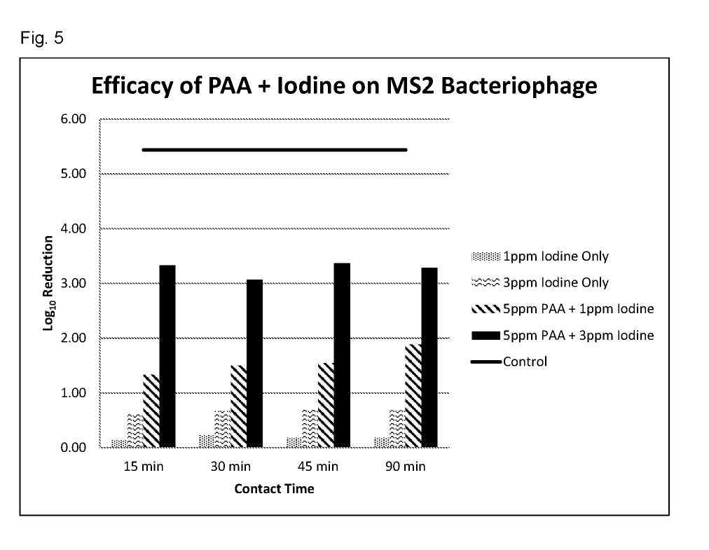

The effect of PAA and iodine on the reduction of MS2 bacteriophage as a function of contact time is shown in FIG. 5. These data indicated that the combination of PAA and either 1 ppm or 3 ppm of iodine increased the microbial log reduction by 2-3 additional log units at all contact times tested.

What is claimed is:

1. A method of water disinfection, the method comprising:
a) adding a peracid and iodine to the water, wherein the final concentration of the peracid in the water is between about 0.1 ppm and 20 ppm, and the final concentration of the iodine in the water is between about 0.01 and 5 ppm;
b) contacting the water with the peracid and the iodine for a time sufficient to reduce the concentration of microorganisms in the water.

2. The method of claim 1, wherein the water is selected from the group consisting of drinking water, industrial wastewater, municipal wastewater, combined sewer overflow, process water, rain water, flood water, and storm runoff water.

3. The method of claim 1, where in the peracid is peracetic acid or performic acid or a combination thereof.

4. The method of claim 1, where in the final concentration of the peracid in the water is from about 0.1 ppm to about 5 ppm.

5. The method of claim 1, wherein the final concentration of the peracid in the water is from about 0.5 ppm to about 1 ppm

6. The method of claim 1, wherein the final concentration of the iodine in the water is from about 0.05 ppm to about 3 ppm.

7. The method of claim 1, where in the final concentration of the iodine in the water is from about 0.2 ppm to about 3 ppm.

8. The method of claim 1, wherein the iodine is an iodine salt or an aqueous iodine solution.

9. The method of claim 1, wherein the peracid and the iodine are added to the water simultaneously.

10. The method of claim 1, where in the peracid and the iodine are added to the water sequentially.

11. The method of claim 10, wherein the peracid is added to the water before the iodine is added to the water.

12. The method of claim 10, where in the peracid is added to the water after the iodine is added to the water.

13. The method of claim 1, wherein the water comprises a water stream.

14. The method of claim 13, wherein the peracid is added to the water stream at one or more application points within the water stream.

15. The method of claim 13, wherein the water stream is contacted with the peracid at one or more application points within the water stream.

16. The method of claim 1, further comprising providing the water.

17. The method of claim 1, wherein the microorganism is a bacterium, a bacteriophage, a virus, a fungus, a protozoa, or a parasite.

18. The method of claim 17, wherein the microorganism is a microbial indicator organism.
